(19) United States
(12) Patent Application Publication
(10) Pub. No.: US 2007/0098226 A1
(43) Pub. Date: May 3, 2007

(54) Hard disk apparatus with a biometrics sensor and method of protecting data therein

(75) Inventor: Bruce C.S. Chou, Hsin Chu (TW)

Correspondence Address: BIRCH STEWART KOLASCH & BIRCH, PO BOX 747, FALLS CHURCH, VA, 22040-0747, US

(73) Assignee: LIGHTUNING TECH. INC.

(21) Appl. No.: 11/585,872

(22) Filed: Oct. 25, 2006

(30) Foreign Application Priority Data
Oct. 27, 2005 (TW) 094137592

(51) Int. Cl. G06K 9/00

(52) U.S. Cl. 382/115; 340/5.52

(57) ABSTRACT

A hard disk apparatus includes a host interface connected to a terminal host, a control module connected to the host interface, and a biometrics sensor and a hard disk both connected to the control module. The firmware of the control module communicates with the terminal host by handshakes and enables the terminal host to automatically download a biometrics AP and biometrics template data in the hard disk. Then, the control module receives a sensing instruction to control the biometrics sensor to read to-be-recognized biometrics data of a to-be-recognized user and to transfer the to-be-recognized biometrics data to the terminal host. Then, the control module receives a verification result outputted by the terminal host and enables a security block to be accessed by the terminal host when the verification result is successful, or otherwise disables the security block from being accessed by the terminal host. An external hard disk enclosure containing the biometrics sensor is also disclosed.

### BACKGROUND OF THE INVENTION

1. Field of the Invention

The invention relates in general to a hard disk apparatus and a method of protecting data stored in the hard disk apparatus, and more particularly to an external hard disk enclosure or hard disk apparatus including a biometrics sensor and a method of protecting data storing therein.

2. Description of the Related Art

The conventional method for protecting the personal data is often made by way of password protection. However, using the password to protect the personal data is troublesome because the user tends to forget the password and the password may also be dangerously cracked. Hence, the biometrics identification methods based on the biometrics data particular to the personal, such as the fingerprint, voice, signature, and iris, have been gradually developed in order to provide the more complete and effective data protection methods. The advantages are that the biometrics feature is always kept on the user and the user does not need to remember the feature, the biometrics feature cannot be stolen, and the fingerprint biometrics feature protection method is strict and very convenient.

Recently, owing to the invention of the chip-type fingerprint sensor, the miniaturized electrical product incorporated with the fingerprint identification device becomes the technology that can be implemented. The associated technology can be found in the above-mentioned patent applications to the inventor: (a) U.S. patent application Ser. No. 10/403,052 (US20030190061A1), filed on Apr. 1, 2003, entitled “CAPACITIVE FINGERPRINT SENSOR”; (b) U.S. patent application Ser. No. 10/434,833 (US20030215976A1), filed on May 13, 2003, entitled “PRESSURE TYPE FINGERPRINT SENSOR FABRICATION METHOD”; (c) U.S. patent application Ser. No. 10/414,214 (US20040208345A1), filed on Apr. 16, 2003, and entitled “THERMOELECTRIC SENSOR FOR FINGERPRINT THERMAL IMAGING”; and (d) U.S. patent application Ser. No. 10/638,371 (US20040046574A1), filed on Aug. 12, 2003, and entitled “CAPACITIVE MICRO PRESSURE SENSING MEMBER AND FINGERPRINT SENSOR USING THE SAME”. Thus, span personal applications, such as the portable electrical products with the fingerprint identification function, have been developed.

More particularly, the aspect of the storage medium protection is an important development item incorporated with the biometrics identification method. For example, U.S. Pat. No. 4,582,985 issued on Apr. 15, 1986 has disclosed a storage medium protection method, in which the personal data stored in the personal ID card device is protected by way of fingerprint authentication. The protected data stored in the card device can be outputted for the subsequent processing or authentication procedures only after the fingerprint identification procedure passes. The transversal dimension of this device is the same as that of the generally used credit card. This device, which is a completely independent fingerprint identification device because the fingerprint capture and identification are performed in the same device, includes a fingerprint sensor, an image processing and identification module, and a memory. Although the application object thereof is to prevent the personal credit card from being counterfeited, this device has a high price because the image processing and identification module needs a high-level microprocessor, such as a 32-bit RISC processor or DSP chip, in addition to the fingerprint sensor is needed, which causes the independent identification device not easy to be popularized.

U.S. Pat. No. 6,213,403 discloses a storage device having a fingerprint sensor and utilizing the PCMCIA interface to connect to the computer. Similarly, the concept of this device is almost the same as that of the '985 patent because this device is also an independent fingerprint identification device, which possesses the fingerprint capture and identification functions, and the data stored in the storage device can be accessed only when the fingerprint authentication passes. The only one difference therebetween is that the '403 patent utilizes a standard PCMCIA interface. Meanwhile, the card of the PCMCIA device is completely inserted into the computer slot. Consequently, the '403 patent has to expose the fingerprint sensor device for usage according to the complicated mechanism designs, which may increase the unstability and cost of the mechanism.

Similarly, EP1204079A1 patent discloses the data protection concept of an independent fingerprint identification module, which is the same as the '985 and '403 patents except for that the communication interface of the '079 patent is the golden finger configuration that is for the SD card interface.

WO 02/42887A2 patent discloses the data protection concept of an independent fingerprint identification module, which is the same as the '985, '403, and '079 patents except for that the '887 patent utilizes the USB interface to communicate with the terminal system. This device is similar to the flash memory disk that is popular over the market, but this device has the independent fingerprint processing and identification module.

U.S. Patent publication No. 2003/005337 discloses the data protection concept of an independent fingerprint identification module, which is the same as the '985, '403, and '079 patents, and utilizes the USB as the communication interface. Similarly, the device of '337 patent is also an independent fingerprint identification device.

GB2387933 patent also discloses an independent fingerprint identification device, which has a concept and device design almost similar to those of the '887 and '337 patents, wherein the fingerprint capture and identification are performed in the same device.

Heretofore, the prior arts have a common feature of providing an independent fingerprint identification device including a fingerprint sensor, and a fingerprint image processing and identification IC. Such a design is intuitive and easily implemented and there is no need to install the fingerprint application program in the terminal system and the convenience of plug-and-play function may be provided. However, the prior art devices have an important problem of the high prices because a fingerprint image processing and identification IC and its associated memory components have to be utilized. Usually, the IC is the 32-bit RISC (Reduced Instruction Set Computer) or DSP (Digital Signal Processor) so as to perform the fingerprint identification effectively. Consequently, the conventional portable storage device with a fingerprint sensor has the drawback of high cost.

In order to solve the high cost problem, it is preferred to utilize the microprocessor of the terminal system to execute the fingerprint image processing and identification so as to effectively reduce the cost. However, the prior arts had not definitely disclosed the solution to the method. The reason will be described in the following.

If the fingerprint image processing and identification works are to be transferred from the storage device to the microprocessor of the terminal system, the disclosed device must have the function of causing the fingerprint application program, which includes the fingerprint image processing, identification and encrypting/decrypting sub-programs, and a fingerprint matching program, to be automatically run or executed in the terminal system so as to achieve the plug-and-play function and facilitate the usage in any other terminal system. The above-mentioned prior arts, however, do not provide this solution.

Alternatively, as shown in U.S. Patent Publication No. 2003/005337, it is possible to install the fingerprint processing and identification programs in the terminal system. Such a design, however, disables the user from using the device over various terminal systems, or the user has to spend time to laboriously install the driver and application programs first in the terminal systems before using. The conventional method is to provide an optical disk for storing the drivers for the memory and the drivers for the fingerprint sensor of the storage device so that the user can install the suitable drivers and enable the storage device to be used. In this case, each time when the computer systems are firstly set, the user has to carry the portable storage device together with the optical disk so that he or she can use the storage device in other computer systems. Although it is possible to download the driver through the network, it is not a convenient way because some computers cannot connect to the network.

### SUMMARY OF THE INVENTION

It is therefore an object of the invention to provide a hard disk apparatus having a biometrics sensor, wherein the hard disk apparatus is connected to a terminal host and cooperates with the terminal host to provide the function of sensing the biometrics data without increasing too much cost of the hard disk apparatus.

Another object of the invention is to provide a hard disk apparatus, which has a biometrics sensor and can hide the biometrics sensor with respect to a terminal host in order to simply the method of controlling the hard disk apparatus.

The invention achieves the above-identified objects by providing a hard disk apparatus including a host interface to be connected to a terminal host, a control module, which is connected to the host interface, for storing firmware, a biometrics sensor, which is connected to the control module, for sensing to-be-recognized biometrics data of a to-be-recognized user, and a hard disk, which has a magnetic disc and a spindle motor for rotating the magnetic disc, and is connected to the control module and partitioned into at least three blocks. The blocks include an application program block for storing at least one biometrics application program (AP), a security block for storing to-be-protected data, and a hidden block for storing biometrics template data. The firmware of the control module is configured, when the terminal host executes the at least one biometrics AP, to: enable the terminal host to automatically download the biometrics template data; receive a biometrics data sensing instruction, which is outputted when the terminal host is executing the biometrics AP, to control the biometrics sensor to read the to-be-recognized biometrics data of the to-be-recognized user and to transfer the to-be-recognized biometrics data to the terminal host; and receive a verification result outputted after the terminal host processes and compares the to-be-recognized biometrics data with the biometrics template data using the biometrics AP, and configure the security block as a removable hard disk or a fixed hard disk to enable the security block to be accessed by the terminal host when the verification result is successful, or otherwise disable the security block from being accessed by the terminal host.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a schematic illustration showing a connection state of a terminal host and a hard disk apparatus according to a first embodiment of the invention.

FIG. 2 is a flow chart showing a method of protecting data stored in a hard disk apparatus according to a second embodiment of the invention.

### DETAILED DESCRIPTION OF THE INVENTION

The feature of the invention is to solve two prior art problems mentioned hereinabove.

The first solution is that the invention device utilizes a microprocessor of a terminal system to execute the biometrics image processing and verification processes. So, the cost can be greatly reduced compared with the prior art device containing the stand-alone biometrics identification microprocessor.

The second solution is that the invention device without the stand-alone biometrics identification microprocessor can automatically download the biometrics AP to the terminal system such that the invention device can be portable and used in various terminal systems having different operation systems (OSs) and language environments.

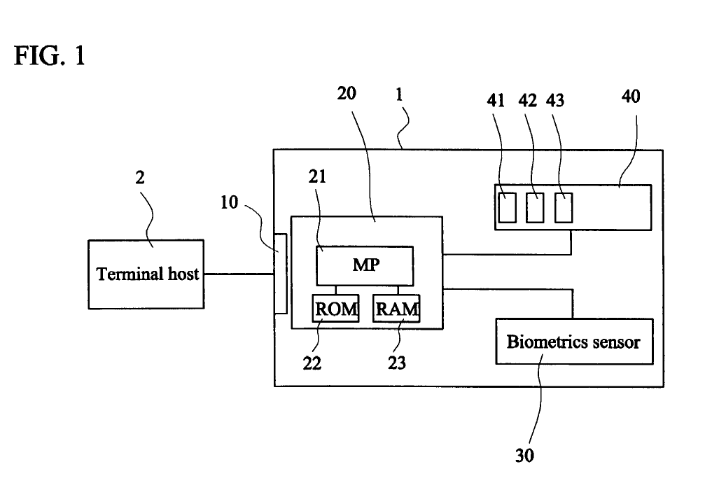

FIG. 1 is a schematic illustration showing a connection state of a terminal host and a hard disk apparatus according to a first embodiment of the invention. It is to be noted that the invention mainly discloses a hard disk apparatus externally connected to a computer apparatus. The hard disk apparatus may be usually configured to include an external hard disk enclosure and a hard disk, which may be assembled into the hard disk enclosure in the factory before shipment or may be purchased and assembled by a consumer. Thus, the invention device of FIG. 1 may be regarded as being composed of an external hard disk enclosure with a biometrics sensor, and a hard disk installed into the enclosure. Referring to FIG. 1, the hard disk apparatus 1 of this embodiment includes a host interface 10, a control module 20, a biometrics sensor 30 and a hard disk 40. The hard disk 40 has a magnetic disc and a spindle motor for rotating the magnetic disc. The host interface 10 may be, for example, a universal serial bus (USB) interface, a PCMCIA interface, a PCI express interface, an IEEE 1394 interface, a SATA interface or any other standard interface to be connected to a terminal host 2.

The control module 20 is connected to the host interface 10 and stores the firmware. The control module 20 briefly includes a microprocessor (MP) 21, a random access memory (RAM) 22 and a read only memory (ROM) 23. The RAM 22 serves as a working memory for data processing, and the ROM 23 stores the firmware for enabling the hard disk apparatus 1 to work. The microprocessor 21, the RAM 22 and the ROM 23 may be integrated into a single chip. Thus, the control module 20 is to communicate with the terminal host 2 and manage the hard disk 40 and the biometrics sensor 30.

The biometrics sensor 30 connected to the control module 20 senses to-be-recognized biometrics data of a to-be-recognized user and authorized biometrics data of an authorized user. For example, the biometrics sensor 30 may be a voice sensor for sensing voice data, an iris sensor for sensing an iris of an eye, an optical image sensor for sensing a face, a signature sensor for sensing a signature, an area-type fingerprint sensor, a sweep-type fingerprint sensor or any other biometrics sensor. The area-type fingerprint sensor senses fingerprint data of a finger placed thereon, while the sweep-type fingerprint sensor senses fingerprint data of a finger sweeping thereacross.

The hard disk 40 is connected to the control module 20 and may be assembled by the consumer in practice. Thus, the personal formatting software available from an optical disc or may be downloaded from the network, has to be provided in conjunction with the external hard disk enclosure such that the consumers can format the disk by themselves. The formatting operation is to format and partition the hard disk 40 into an application program block 41, a security block 42 and a hidden block 43. The hard disk 40 may be a 3.5″ hard disk, a 2.5″ hard disk, a 1.8″ hard disk, a 1″ hard disk or a 0.85″ micro hard disk, which has an IDE interface, a SCSI interface, a CF interface, a SATA interface or any other standard storage interface. The application program block 41 stores one or a plurality of biometrics APs, and the security block 42 stores at least one to-be-protected data. The hidden block 43 stores biometrics template data and a key for the encrypting/decrypting program. It is to be noted that the hard disk 40 and the biometrics sensor 30 may be connected to the control module 20 through the same storage interface, or the control module may provide a specific interface, such as the SPI or the parallel interface, to be connected to the biometrics sensor 30. In these two cases, because the hard disk 40 and the biometrics sensor 30 are controlled by the control module 20 and are not directly controlled by the terminal host 2, the terminal host 2 may regard the hard disk 40 and the biometrics sensor 30 as one storage device.

The firmware of the control module 20 is configured to enable the terminal host 2 to automatically download and execute one of the biometrics APs by, for example, simulating the application program block 41 of the hard disk 40 into a CD-ROM booting area so that the auto execution function can be produced. That is, the firmware enables the terminal host 2 to automatically execute the biometrics AP. In another embodiment, the application program block 41 of the hard disk 40 may be set as a read-only fixed hard disk or a read-only removable hard disk with the biometrics APs being executed by a manually click. In addition, an “autorun.inf” file is stored in the application program block 41 such that the OS (e.g., Microsoft windows XP) of the terminal host 2 automatically runs the application program execution file recorded in the “autorun.inf” file according to the internal setting, and the function of automatically executing the application is similar to that of the CD-ROM. There are two methods of executing the application. One method is to execute the biometrics AP directly in the main memory of the terminal host 2 without installing the biometrics AP in the OS of the terminal host 2. Consequently, when the hard disk apparatus 1 is removed from the terminal host 2, the biometrics AP in the main memory of the terminal host 2 is closed and cleared. The other method is to install the biometrics AP in the OS of the terminal host 2 and execute the biometrics AP installed in the OS. In this case, a biometrics AP menu may be selectively installed in the OS, disposed on the system tray or attached to the function menu of any other application program. After the automatic execution completes, the application program block 41 may be kept or closed. Then, after the biometrics identification passes, the security block 42 is designed as a removable hard disk or a fixed hard disk, and then the application program block 41 of the file explorer may be closed and switched to the security block 42.

Alternatively, the firmware of the control module 20 is configured to enable the OS of the terminal host 2 to automatically show the biometrics APs in the application program block 41. For example, when the hard disk apparatus 1 is inserted into the terminal host 2, the OS of the terminal host 2 shows the biometrics APs in the application program block 41. In this case, the biometrics AP has to be clicked for execution manually in two ways. The first way is to execute the biometrics AP in the main memory of the terminal host 2 directly without installing the biometrics AP in the OS of the terminal host 2. Thus, when the hard disk apparatus 1 is removed, the biometrics AP in the main memory of the terminal host 2 is closed and cleared. The second way is to install the biometrics AP in the OS of the terminal host 2 and then execute the biometrics AP, wherein a biometrics AP menu may be selectively generated in the OS. For example, the AP menu may exist in a system tray or may be attached to a function menu of any other application program. After the automatic execution function completes, the application program block 41 may be kept or closed. Then, after the biometrics identification passes, the security block 42 is configured as a removable hard disk or a fixed hard disk. Then, the file explorer may close the application program block 41 and switch to the security block 42 to show the security block 42 as a disk. The function of automatically executing the firmware may also be omitted, and the user may execute the application program manually.

When the firmware of the control module 20 detects no biometrics template data stored in the hidden block 43, the firmware receives a biometrics data sensing instruction, which is outputted from the terminal host 2 when the host 2 is executing the biometrics AP, to control the biometrics sensor 30 to read the authorized biometrics data of the authorized user and transfer the authorized biometrics data to the terminal host 2. Then, the control module 20 receives the biometrics template data, which is generated after the terminal host 2 processes the authorized biometrics data using the biometrics AP and stores the biometrics template data into the hidden block 43.

When the firmware of the control module 20 detects the biometrics template data stored in the hidden block 43, the firmware enables the terminal host 2 to automatically download the biometrics template data, to receive a biometrics data sensing instruction, which is outputted from the terminal host 2 when the host 2 is executing the biometrics AP, to control the biometrics sensor 30 to read the to-be-recognized biometrics data of the to-be-recognized user and transfer the to-be-recognized biometrics data to the terminal host 2. Then, the firmware receives a verification result, which is outputted from the terminal host 2 after the host 2 processes and compares the to-be-recognized biometrics data with the biometrics template data using the biometrics AP, and enables the security block 42 to be accessed by the terminal host 2 when the verification result is successful, or otherwise disables the security block 42 from being accessed by the terminal host 2.

In addition, it is also possible to encrypt the to-be-protected data and then store encrypted data in the security block 42 to increase the level of data protection. In this case, the hidden block 43 further stores a encrypting/decrypting key, and the firmware may further enable the terminal host 2 to automatically download the encrypting/decrypting key such that the biometrics AP of the terminal host 2 encrypts/decrypts the to-be-protected data, which is read from or written into the security block 42, according to the encrypting/decrypting key.

In addition, another embodiment of this invention also provides an external hard disk enclosure, in which a hard disk 40 may be mounted. As shown in FIG. 1, removing the hard disk 40 may form the architecture of the external hard disk enclosure according to the invention. Thus, the external hard disk enclosure includes a host interface 10, a control module 20 and a biometrics sensor 30. The host interface 10 is to be connected to a terminal host 2. The control module 20 is connected to the host interface 10 and the hard disk 40 and stores the firmware. The biometrics sensor 30 is connected to the control module 20 and senses authorized biometrics data of an authorized user. The firmware of the control module 20 is configured to receive a biometrics data sensing instruction, which is outputted from the terminal host 2, to control the biometrics sensor 30 to read the authorized biometrics data and transfer the authorized biometrics data to the terminal host 2, and to receive biometrics template data, which is generated after the terminal host 2 processes the authorized biometrics data, and to store the biometrics template data into the hard disk 40.

After the user installs the hard disk 40 to the enclosure and connects the enclosure to the terminal host 2, the application program for the enclosure may be installed from an optical disc or the network. The hard disk 40 is partitioned into at least three blocks including an application program block 41 for storing a plurality of biometrics APs, a security block 42 for storing to-be-protected data, and a hidden block 43 for storing biometrics template data.

After the enclosure is connected to another terminal host, it is unnecessary to again install the application program in the terminal host and the function of automatic execution may be enabled. Thus, the firmware may further be configured to simulate the application program block 41 as a CD-ROM booting area or to set the application program block 41 as a read-only fixed hard disk or removable disk, and to enable the terminal host 2 to automatically or manually download and execute one of the biometrics APs.

In order to automatically complete the subsequent biometrics data verification, the firmware may further be configured to: enable the terminal host 2 to automatically download the biometrics template data; receive the biometrics data sensing instruction, which is outputted from the terminal host 2 when the host is executing the biometrics AP, to control the biometrics sensor 30 to read to-be-recognized biometrics data of a to-be-recognized user and transfer the to-be-recognized biometrics data to the terminal host 2; and receive a verification result, which is outputted after the terminal host 2 processes and compares the to-be-recognized biometrics data with the biometrics template data using the biometrics AP, and enable the security block 42 to be accessed by the terminal host 2 when the verification result is successful or otherwise disable the security block 42 from being accessed by the terminal host 2.

As mentioned hereinabove, the hidden block 43 further stores an encrypting/decrypting key, and the firmware may further enable the terminal host 2 to automatically download the encrypting/decrypting key such that the biometrics AP encrypts/decrypts to-be-protected data, which is read from or written into the security block 42, according to the encrypting/decrypting key. In addition, the biometrics AP is installed in the OS of the terminal host 2. Alternatively, the biometrics AP is directly executed in a main memory of the terminal host 2 so that the terminal host 2 can automatically clear the biometrics AP after the enclosure is disconnected from the terminal host 2.

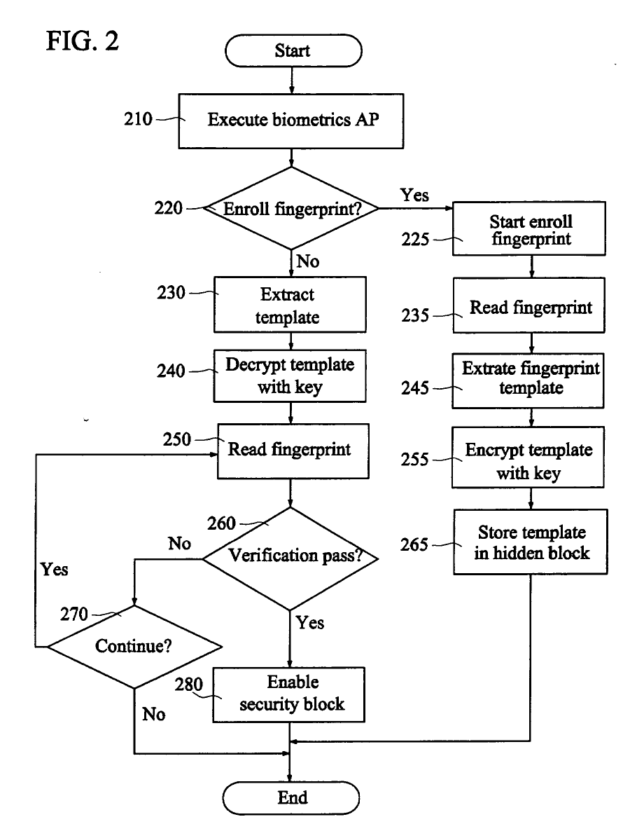

FIG. 2 is a flow chart showing a method of protecting data stored in a hard disk apparatus according to a second embodiment of the invention.

As shown in FIGS. 2 and 1, the method of protecting data stored in the hard disk apparatus 1, after the apparatus 1 is connected to the terminal host 2, will be described in the following. Herein, the fingerprint serves as the biometrics data.

First, the apparatus 1 communicates with the terminal host 2 through the host interface 10 and enables the terminal host 2 to automatically download and execute one of the biometrics APs, as shown in step 210. Then, in step 220, the terminal host 2 shows a window for the user to select to enter a biometrics enrolling mode (step 225) or a biometrics identification mode (step 230), which may also be entered by way of automatic judgement.

If the biometrics enrolling mode is to be entered, the terminal host 2 outputs sound and optical signals to inform the user to start enrolling the biometrics data, such as the fingerprint data. The control module 20 receives the biometrics data sensing instruction, which is outputted from the terminal host 2 when the host is executing the biometrics AP, to control the biometrics sensor 30 to read the authorized biometrics data of the authorized user and transfer the authorized biometrics data to the terminal host 2, which processes the data to extract the fingerprint template data (steps 235 and 245). Then, the terminal host 2 processes the biometrics template data using the biometrics AP and transfers the processed biometrics template data to the hidden block 43 for storage. The control module 20 receives the biometrics template data, which is generated after the terminal host 2 processes the authorized biometrics data using the biometrics AP, and stores the biometrics template data into the hidden block 43. Alternatively, the biometrics AP may encrypt the biometrics template data (step 255) according to the key, and then the encrypted biometrics template data is transferred to the hidden block 43 for storage (step 265).

If the biometrics identification mode is to be entered, the control module 20 enables the terminal host 2 to automatically download the biometrics template data (step 230). Then, the fingerprint template data may be decrypted according to the key (step 240). Next, the control module 20 receives the biometrics data sensing instruction, which is outputted by the terminal host 2 when the host 2 is executing the biometrics AP, to control the biometrics sensor 30 to read the to-be-recognized biometrics data of the to-be-recognized user, and to transfer the to-be-recognized biometrics data to the terminal host 2, as shown in step 250. Then, the terminal host 2 processes and compares the to-be-recognized biometrics data with the biometrics template data to judge whether the verification passes, as shown in step 260. The control module 20 receives the verification result, outputted after the terminal host 2 processes and compares the to-be-recognized biometrics data with the biometrics template data using the biometrics AP, and enables the security block 42 to be accessed by the terminal host 2 (step 280) when the verification result is successful, or otherwise disables the security block 42 from being accessed by the terminal host 2, or asks the user whether the verification has to be executed again (step 270).

This method may further include the step of enabling the terminal host 2 to automatically download the encrypting/decrypting key stored in the hidden block 43 such that the biometrics AP encrypts/decrypts the to-be-protected data, which is read from or written into the security block 42, according to the encrypting/decrypting key.

According to the construction of the invention, the connected device viewed from the computer system no longer includes a hard disk and a biometrics sensor, so the terminal host does not have to control the operations of two devices. Instead, the connected device viewed from the computer system only includes one portable storage device, so the computer system only has to control the operation of one device. The operations of the hard disk and the biometrics sensor in the portable storage device can be controlled by the control module. In addition, the external hard disk enclosure of the invention enables the user to install his/her desired hard disk, and then to protect the data through the application program and the biometrics sensor. In addition, once the hard disk is successfully installed, the external hard disk enclosure can be plugged and played over various terminal hosts.

While the invention has been described by way of examples and in terms of preferred embodiments, it is to be understood that the invention is not limited to the disclosed embodiments. To the contrary, it is intended to cover various modifications. Therefore, the scope of the appended claims should be accorded the broadest interpretation so as to encompass all such modifications. For instance, the storage medium of the invention may be extended from the hard disk to the non-volatile memory, such as a flash memory, a read only memory (ROM), a programmable ROM (PROM), a magnetic random access memory (MRAM) or an electrically erasable programmable read only memory (EEPROM).

What is claimed is:

1. A hard disk apparatus, comprising:
a host interface to be connected to a terminal host;
a control module, which is connected to the host interface, for storing firmware;
a biometrics sensor, which is connected to the control module, for sensing to-be-recognized biometrics data of a to-be-recognized user; and
a hard disk, which has a magnetic disc and a spindle motor for rotating the magnetic disc, and is connected to the control module and partitioned into at least three blocks, which comprise:
an application program block for storing at least one biometrics AP (Application Program);
a security block for storing to-be-protected data; and
a hidden block for storing biometrics template data, wherein the firmware of the control module is configured, when the terminal host executes the at least one biometrics AP, to:
enable the terminal host to download the biometrics template data;
receive a biometrics data sensing instruction, which is outputted when the terminal host is executing the biometrics AP, to control the biometrics sensor to read the to-be-recognized biometrics data of the to-be-recognized user and to transfer the to-be-recognized biometrics data to the terminal host; and
receive a verification result outputted after the terminal host processes and compares the to-be-recognized biometrics data with the biometrics template data using the biometrics AP, and configure the security block as a removable hard disk or a fixed hard disk to enable the security block to be accessed by the terminal host when the verification result is successful, or otherwise disable the security block from being accessed by the terminal host.

2. The apparatus according to claim 1, wherein the hidden block further stores an encrypting/decrypting key and the firmware further enables the terminal host to automatically download the encrypting/decrypting key such that the biometrics AP of the terminal host encrypts/decrypts the to-be-protected data read from or written into the security block according to the encrypting/decrypting key.

3. The apparatus according to claim 1, wherein the host interface is a universal serial bus (USB) interface, a PCMCIA interface, a PCI express interface, an IEEE 1394 interface or a SATA interface.

4. The apparatus according to claim 1, wherein the biometrics sensor is a voice sensor, an iris sensor, a signature sensor, an optical image sensor, an area-type fingerprint sensor or a sweep-type fingerprint sensor.

5. The apparatus according to claim 1, wherein the biometrics AP is installed in an OS (Operation System) of the terminal host.

6. The apparatus according to claim 1, wherein the biometrics AP is directly executed in a main memory of the terminal host, and enables the terminal host to automatically clear the biometrics AP when the hard disk apparatus is disconnected from the terminal host.

7. A hard disk apparatus, comprising:
a host interface to be connected to a terminal host;
a control module, which is connected to the host interface, for storing firmware;
a biometrics sensor, which is connected to the control module, for sensing authorized biometrics data of an authorized user; and
a hard disk, which has a magnetic disc and a spindle motor for rotating the magnetic disc, and is connected to the control module and partitioned into at least three blocks, which comprise:
an application program block for storing at least one biometrics AP (Application Program);
a security block for storing to-be-protected data; and
a hidden block for storing biometrics template data, wherein the firmware of the control module is configured, when the terminal host executes the at least one biometrics AP, to:
receive a biometrics data sensing instruction, which is outputted when the terminal host is executing the biometrics AP, to control the biometrics sensor to read the authorized biometrics data of the authorized user and transfer the authorized biometrics data to the terminal host; and
receive the biometrics template data, which is generated after the terminal host processes the authorized biometrics data using the biometrics AP, and store the biometrics template data in the hidden block.

8. The apparatus according to claim 7, wherein the firmware of the control module is further configured to:
enable the terminal host to automatically download the biometrics template data;
receive the biometrics data sensing instruction, which is outputted when the terminal host is executing the biometrics AP, to control the biometrics sensor to read to-be-recognized biometrics data of a to-be-recognized user and transfer the to-be-recognized biometrics data to the terminal host; and
receive a verification result, which is outputted after the terminal host processes and compares the to-be-recognized biometrics data with the biometrics template data, using the biometrics AP, and enable the security block to be accessed by the terminal host when the verification result is successful, or otherwise disable the security block from being accessed by the terminal host.

9. The apparatus according to claim 8, wherein the hidden block further stores an encrypting/decrypting key and the firmware further enables the terminal host to automatically download the encrypting/decrypting key such that the biometrics AP of the terminal host encrypts/decrypts the to-be-protected data read from or written into the security block according to the encrypting/decrypting key.

10. The apparatus according to claim 8, wherein the host interface is a universal serial bus (USB) interface, a PCMCIA interface, a PCI express interface, an IEEE 1394 interface or a SATA interface.

11. The apparatus according to claim 8, wherein the biometrics sensor is a voice sensor, an iris sensor, a signature sensor, an optical image sensor, an area-type fingerprint sensor or a sweep-type fingerprint sensor.

12. The apparatus according to claim 7, wherein the biometrics AP is installed in an OS (Operation System) of the terminal host.

13. The apparatus according to claim 7, wherein the biometrics AP is directly executed in a main memory of the terminal host, and enables the terminal host to automatically clear the biometrics AP when the hard disk apparatus is disconnected from the terminal host.

14. A method of protecting data stored in a hard disk apparatus, wherein the hard disk apparatus comprises: a host interface to be connected to a terminal host; a control module, which is connected to the host interface and stores firmware; a biometrics sensor, which is connected to the control module, for sensing authorized biometrics data of an authorized user; and a hard disk, which has a magnetic disc and a spindle motor for rotating the magnetic disc, and is connected to the control module and partitioned into at least three blocks, which comprise an application program block for storing at least one biometrics AP (Application Program), a security block for storing to-be-protected data, and a hidden block for storing biometrics template data, the method comprising, when the terminal host executes the at least one biometrics AP, the steps of:
entering a biometrics enrolling mode or a biometrics identification mode;
in the biometrics enrolling mode:
receiving a biometrics data sensing instruction, which is outputted when the terminal host is executing the biometrics AP, to control the biometrics sensor to read the authorized biometrics data of the authorized user and to transfer the authorized biometrics data to the terminal host; and
receiving the biometrics template data, which is generated after the terminal host processes the authorized biometrics data using the biometrics AP, and storing the biometrics template data to the hidden block; and
in the biometrics identification mode:
enabling the terminal host to download the biometrics template data;
receiving the biometrics data sensing instruction, which is outputted when the terminal host is executing the biometrics AP, to control the biometrics sensor to read to-be-recognized biometrics data of a to-be-recognized user and transferring the to-be-recognized biometrics data to the terminal host; and
receiving a verification result, which is outputted after the terminal host processes and compares the to-be-recognized biometrics data with the biometrics template data according to the biometrics AP, and configuring the security block as a removable hard disk or a fixed hard disk to enable the security block to be accessed by the terminal host when the verification result is successful, or otherwise disable the security block from being accessed by the terminal host.

15. The method according to claim 14, further comprising the steps of:
enabling the terminal host to automatically download an encrypting/decrypting key stored in the hidden block, such that the biometrics AP of the terminal host encrypts/decrypts the to-be-protected data read from or written into the security block according to the encrypting/decrypting key.

16. The method according to claim 14, wherein the biometrics AP is installed in an OS (Operation System) of the terminal host.

17. The method according to claim 14, wherein the biometrics AP is directly executed in a main memory of the terminal host, and enables the terminal host to automatically clear the biometrics AP when the hard disk apparatus is disconnected from the terminal host.

18. An external hard disk enclosure, in which a hard disk having a magnetic disc and a spindle motor for rotating the magnetic disc may be mounted, the hard disk enclosure comprising:
a host interface to be connected to a terminal host;
a control module, which is connected to the host interface and the hard disk, for storing firmware;
a biometrics sensor, which is connected to the control module, for sensing authorized biometrics data of an authorized user, wherein the firmware of the control module is configured to:
receive a biometrics data sensing instruction, which is outputted from the terminal host, to control the biometrics sensor to read the authorized biometrics data of the authorized user and transfer the authorized biometrics data to the terminal host; and
receive biometrics template data, which is generated after the terminal host processes the authorized biometrics data, and store the biometrics template data into the hard disk.

19. The enclosure according to claim 18, wherein the hard disk is partitioned into at least three blocks, which comprise:
an application program block for storing at least one biometrics AP (Application Program);
a security block for storing to-be-protected data; and
a hidden block for storing the biometrics template data.

20. The enclosure according to claim 19, wherein the firmware is further configured to:
simulate the application program block into a CD-ROM booting area or set the application program block as a fixed hard disk; and
enable the terminal host to automatically download and execute the biometrics AP.

21. The enclosure according to claim 20, wherein the firmware is further configured to:
enable the terminal host to automatically download the biometrics template data;
receive the biometrics data sensing instruction, which is outputted when the terminal host is executing the biometrics AP, to control the biometrics sensor to read to-be-recognized biometrics data of a to-be-recognized user and transfer the to-be-recognized biometrics data to the terminal host; and
receive a verification result, which is outputted from the terminal host after the terminal host processes and compares the to-be-recognized biometrics data with the biometrics template data using the biometrics AP, and enable the security block to be accessed by the terminal host when the verification result is successful, or otherwise disable the security block from being accessed by the terminal host.

22. The enclosure according to claim 20, wherein the hidden block further stores an encrypting/decrypting key, and the firmware further enables the terminal host to automatically download the encrypting/decrypting key such that the biometrics AP of the terminal host encrypts/decrypts the to-be-protected data, which is read from or written into the security block, according to the encrypting/decrypting key.

23. The enclosure according to claim 20, wherein the biometrics AP is installed in an OS (Operation System) of the terminal host.

24. The enclosure according to claim 20, wherein the biometrics AP is directly executed in a main memory of the terminal host such that the terminal host automatically clears the biometrics AP after the hard disk enclosure is disconnected from the terminal host.

25. The enclosure according to claim 18, wherein the host interface is a universal serial bus (USB) interface, a PCMCIA interface, a PCI express interface, an IEEE 1394 interface or a SATA interface.

26. The enclosure according to claim 18, wherein the biometrics sensor is a voice sensor, an iris sensor, a signature sensor, an optical image sensor, an area-type fingerprint sensor or a sweep-type fingerprint sensor.
